(19) United States
(12) Patent Application Publication
(10) Pub. No.: US 2025/0128346 A1
(43) Pub. Date: Apr. 24, 2025

(54) FASTENER HOLE PROTRUSIONS FOR CREATING ELECTRICAL CONTINUITY IN WELDING-TYPE DEVICE HOUSINGS

(71) Applicant: ILLINOIS TOOL WORKS INC., Glenview, IL (US)

(72) Inventor: Nicholas James Dessart, Neenah, WI (US)

(21) Appl. No.: 18/912,828

(22) Filed: Oct. 11, 2024

Related U.S. Application Data
(60) Provisional application No. 63/591,155, filed on Oct. 18, 2023.

(51) Int. Cl. B23K 9/10; B23K 9/16

(52) U.S. Cl. CPC B23K 9/1043; B23K 9/16

(57) ABSTRACT

Some examples of the present disclosure relate to the use of protrusions to create electrical continuity between surfaces of a welding-type device housing. In some examples, protrusions may be positioned proximate fastener holes of a housing surface, thereby allowing for a clamp force applied to fasteners extending through the fastener holes to be transferred to the protrusions. The clamp force combined with a sharpness of the protrusions may allow the protrusions to abrasively move and/or remove an electrically insulating powder coating finish from both the protrusions themselves and/or an adjoining housing surface, thereby exposing an underlying electrically conductive material. The exposed electrically conductive material of the protrusion of one housing surface and the exposed electrically conductive material of the adjoining housing surface may be put in contact with one another to create electrical continuity between the housing surfaces.

### CROSS REFERENCE TO RELATED APPLICATIONS

This application claims priority to, and the benefit of, U.S. Provisional Patent Application No. 63/591,155, filed Oct. 18, 2023, entitled “Fastener Hole Protrusions for Creating Electrical Continuity in Welding-Type Device Housings,” the entire contents of which is hereby incorporated by reference.

### TECHNICAL FIELD

The present disclosure generally relates to welding-type devices, and more particularly to fastener hole protrusions for creating electrical continuity in welding-type device housings.

### BACKGROUND

Welding systems include welding devices that use and/or generate electrical power. For example, welding power supplies generate electrical power for welding applications, and welding wire feeders use electrical power to power feed motors that feed welding wire to welding applications. The internal components of the welding devices are enclosed within housings to protect the components from the elements.

Limitations and disadvantages of conventional and traditional approaches will become apparent to one of skill in the art, through comparison of such systems with the present disclosure as set forth in the remainder of the present application with reference to the drawings.

### SUMMARY

The present disclosure is directed to fastener hole protrusions for creating electrical continuity in welding-type device housings, for example, substantially as illustrated by and/or described in connection with at least one of the figures, and as set forth more completely in the claims.

These and other advantages, aspects and novel features of the present disclosure, as well as details of an illustrated example thereof, will be more fully understood from the following description and drawings.

### BRIEF DESCRIPTION OF THE DRAWINGS

FIG. 1 illustrates an example of a welding-type system, in accordance with aspects of this disclosure.

FIGS. 2a-2c are exploded and assembled views of an example welding-type device that might be used in the welding-type system of claim 1, in accordance with aspects of this disclosure.

FIGS. 3a-3b show example interior faces of a front panel and a rear panel of a housing of the welding-type device shown in FIGS. 2a-2c, in accordance with aspects of this disclosure.

FIGS. 4a-4b show different views of example protrusions encircling a fastener hole, such as might be formed in the front panel and/or rear panels shown in FIGS. 3a-3b, in accordance with aspects of this disclosure.

FIG. 5 shows an example of the protrusions of FIGS. 4a-4b creating electrical continuity between a panel and a base of the housing of the welding-type device shown in FIGS. 2a-2b when the panel is fastened to the base via a fastener, in accordance with aspects of this disclosure.

FIGS. 6a-6c show different views of example alternative protrusions encircling a fastener hole, such as might be formed in certain portions of the housing of the welding-type device shown in FIGS. 2a-2b, in accordance with aspects of this disclosure.

The figures are not necessarily to scale. Where appropriate, similar or identical reference numerals are used to refer to similar or identical components. For example, reference numerals utilizing lettering (e.g., normal fastener holes 220a, protruding fastener holes 220b) refer to instances of the same reference numeral that does not have the lettering (e.g., fastener holes 220).

### DETAILED DESCRIPTION

Some examples of the present disclosure relate to creating electrical continuity between portions (e.g., panels, walls, etc.) of welding-type device housings using protrusions positioned proximate fastener holes of at least one of the housing portions. Electrical continuity between a housing of a welding-type device and an equipment grounding conductor of the welding-type device is required by certain standards of several third party standard setting organizations (e.g., CSA, UL, Intertek, etc.). The standards further require that the different housing portions of the welding-type device housing be electrically continuous with one another. This electrical continuity ensures that any fault electrical current that is conducted into the housing will be subsequently conducted to ground. Some standards similarly require exposed electrically conductive components of the welding-type device be electrically continuous with the housing for similar reasons. The present disclosure contemplates using protrusions positioned proximate fastener holes of a welding-type device housing to create the required electrical continuity, and to do so with fewer drawbacks than other methods for creating electrical continuity.

Unfortunately, creating electrical continuity between portions of a welding-type device housing is often more complicated than simply connecting together the different portions of the welding-type device housings. While some portions of the housings are made of electrically conductive material (e.g., metal), often the material is covered with a powder coating finish (e.g., to protect against rust and/or other damage to the underlying metal material, etc.). As the powder coating finish is electrically insulating (and/or far less electrically conductive than the underlying material), the powder coating can prevent the use of simple physical connection of the housing portions to create electrical continuity.

While there are several ways in which housing portions may still be made electrically continuous despite the electrically insulating powder coating, there are also drawbacks. For example, masking dots can be applied to housing portions before the housing portions are covered in the powder coating finish. Wherever the masking dots are applied, the powder coating is prevented from being applied. When the masking dots are removed after the powder coating process, they reveal portions where no powder coating has been applied, and where the electrically conductive material of the housing portion remains exposed. Exposed electrically conductive metal surfaces of different housing portions can be connected together to create electrical continuity between the housing portions. However, the masking dots themselves can be expensive, and the application of the masking dots can be time consuming, labor intensive, and subject to human error (e.g., w/r/t to correct and/or complete positioning, placement, and/or application).

Another way of creating electrical continuity despite the electrically insulating powder coating is to use a grinder to grind off the powder coating. Like the masking dots, grinding creates housing portions where the electrically conductive surfaces of the housing portions are exposed, allowing for electrical continuity to be created by connecting together the exposed electrically conductive housing portions. However, grinding can generate undesirable and/or unpleasant dust and debris, as well as being time consuming, labor intensive, and/or subject to human error (e.g., w/r/t to correct and/or complete positioning and/or application).

Another way of creating electrical continuity despite the electrically insulating powder coating is the use of paint cutting fasteners. Paint cutting fasteners have a paint cutting ring on an inner side of the fastener head, and paint cutting screw threads on the fastener shank, both of which can be used to cut through the powder coating to get at the underlying conductive surface of a housing portion. And since the paint cutting fastener itself is electrically conductive, electrical continuity between the underlying metal of the housing portions can be created through the paint cutting fastener. While paint cutting fasteners work well (provided they do not become lost, loosened, rusted, etc.), the increased use of electrically insulating (e.g., plastic) bezels limits their usefulness, as there is no underlying electrically conductive material for the paint cutting rings to expose and/or connect with on the insulating bezels.

The present disclosure thus contemplates the use of protrusions positioned around certain fastener holes of welding-type device housing portions, particularly where electrically insulating bezels may be used. In some examples, the protrusions may be sufficiently sharp and/or pointed to puncture, pierce, scrape off, abrade, and/or otherwise move and/or remove the powder coating finish on both an adjoining housing portion and the protrusions themselves. The positioning of the protrusions around the fastener holes also allows for a clamp force applied to fasteners extending through the fastener holes to be transferred to the protrusions, thereby increasing the ability of the protrusions to move and/or remove the insulating paint coating and expose the underlying conductive material. When the powder coatings of the protrusion and adjoining housing portion is moved/removed, the underlying conductive material of both the protrusion and adjoining housing portion may be exposed and physically connected to one another, thereby creating electrical continuity between the housing portion with the protrusions and the adjoining housing portion. The protrusions may further be formed from the housing portions themselves through the same process that makes the fastener holes, thereby creating efficiencies, saving on time/labor, and reducing the potential for human error (e.g., w/r/t to correct and/or complete positioning and/or application).

Some examples of the present disclosure relate to a welding-type device housing, comprising: a first housing wall comprising a first housing wall hole, the first housing wall being comprised of a first electrically conductive material that is covered by an electrically insulating coating; and a second housing wall comprised of the first electrically conductive material, or a second electrically conductive material, the second housing wall comprising a second housing wall hole configured for alignment with the first housing wall hole, and a protrusion positioned proximate the second housing wall hole, the protrusion being configured to, when the second housing wall is fastened to the first housing wall, move an insulating portion of the electrically insulating coating of the first housing wall to expose a conductive portion of the first electrically conductive material that is underneath, and make contact with the conductive portion of the first electrically conductive material that is underneath.

In some examples, the second housing wall is configured to be fastened to the first housing wall by a housing fastener extending through the first housing wall hole and the second housing wall hole, the protrusion being configured to move the insulating portion of the electrically insulating coating of the first housing wall in response to a clamp force being applied to the fastener to fasten the second housing wall to the first housing wall. In some examples, the welding-type device housing further comprises an electrically insulating bezel comprising a bezel hole aligned with the first housing wall hole and the second housing wall hole, the second housing wall hole being positioned between bezel hole and the first housing wall hole, the electrically insulating bezel and the second housing wall being configured to be fastened to the first housing wall by the housing fastener extending through the bezel hole, the first housing wall hole, and the second housing wall hole. In some examples, the second housing wall comprises a front panel wall or a rear panel wall, and the first housing wall comprises a base wall or a baffle wall.

In some examples, the insulating portion of the electrically insulating coating comprises a first insulating portion of a first electrically insulating coating, and the conductive portion of the first electrically conductive material comprises a first conductive portion of the first electrically conductive material, wherein the first or second electrically conductive material of the second housing wall is covered with a second electrically insulating coating, or the first electrically insulating coating, and a second insulating portion of the first or second electrically insulating coating of the protrusion of the second housing wall is configured to be moved in response to the clamp force being applied to the housing fastener, such that a second conductive portion of the first or second electrically conductive material of the protrusion is exposed and makes contact with the first conductive portion of the first electrically conductive material of the first housing wall that was exposed.

In some examples, the contact between the second conductive portion of the protrusion and the first conductive portion of the first housing wall creates electrical continuity between the first housing wall and the second housing wall. In some examples, the protrusion comprises a first protrusion, and the clamp force comprises a first clamp force, the second housing wall further comprising: a third fastener hole configured for alignment with a fourth fastener hole of an exposed welding-type device component that is comprised of the first or second electrically conductive material, or a third electrically conductive material, and a second protrusion proximate the third fastener hole, a third insulating portion of the first or second electrically insulating coating of the second protrusion being configured for removal in response to a second clamp force being applied to a second housing fastener to connect the exposed welding-type device component to the second wall, such that a third conductive portion of the first or second electrically conductive material of the second protrusion is exposed, makes contact with, and becomes electrically continuous with, the exposed welding-type device component.

In some examples, the exposed welding-type device component comprises an electrical switch housing, a gas valve, a regulator, a gauge, a printed circuit board, an electrical port, or a handle. In some examples, the protrusion comprises a stamped or bent portion of the second housing wall, or the protrusion is attached to, and electrically continuous with, the second housing wall. In some examples, the protrusion comprises a first protrusion of a plurality of protrusions encircling the second housing wall hole.

Some examples of the present disclosure relate to a welding-type device, comprising: an enclosed device component comprising: power conversion circuitry configured to receive input power and convert the input power into welding-type output power, or a feed roller configured to feed welding wire from a wire spool to a welding application; and a welding-type device housing enclosing the enclosed device component, the welding-type device housing comprising: a first housing wall comprising a first housing wall hole, the first housing wall being comprised of a first electrically conductive material that is covered by an electrically insulating coating, and a second housing wall comprised of the first electrically conductive material, or a second electrically conductive material, the second housing wall comprising: a second housing wall hole configured for alignment with the first housing wall hole, and a protrusion positioned proximate the second housing wall hole, the protrusion being configured to, when the second housing wall is fastened to the first housing wall, move an insulating portion of the electrically insulating coating of the first housing wall to expose a conductive portion of the first electrically conductive material that is underneath, and make contact with the conductive portion of the first electrically conductive material that is underneath.

In some examples, the second housing wall is configured to be fastened to the first housing wall by a housing fastener extending through the first housing wall hole and the second housing wall hole, the protrusion being configured to move the insulating portion of the electrically insulating coating of the first housing wall in response to a clamp force being applied to the fastener to fasten the second housing wall to the first housing wall. In some examples, the welding-type device housing further comprises an electrically insulating bezel comprising a bezel hole aligned with the first housing wall hole and the second housing wall hole, the second housing wall hole being positioned between bezel hole and the first housing wall hole, the electrically insulating bezel and the second housing wall being configured to be fastened to the first housing wall by the housing fastener extending through the bezel hole, the first housing wall hole, and the second housing wall hole. In some examples, the second housing wall comprises a front panel wall or a rear panel wall, and the first housing wall comprises a base wall or a baffle wall.

In some examples, the insulating portion of the electrically insulating coating comprises a first insulating portion of a first electrically insulating coating, and the conductive portion of the first electrically conductive material comprises a first conductive portion of the first electrically conductive material, wherein the first or second electrically conductive material of the second housing wall is covered with a second electrically insulating coating, or the first electrically insulating coating, and a second insulating portion of the first or second electrically insulating coating of the protrusion of the second housing wall is configured to be moved in response to the clamp force being applied to the housing fastener, such that a second conductive portion of the the first or second electrically conductive material of the protrusion is exposed and makes contact with the first conductive portion of the first electrically conductive material of the first housing wall that was exposed.

In some examples, the contact between the second conductive portion of the protrusion and the first conductive portion of the first housing wall creates electrical continuity between the first housing wall and the second housing wall. In some examples, the protrusion comprises a first protrusion, and the clamp force comprises a first clamp force, the welding-type device further comprising an exposed welding-type device component that is comprised of the first or second electrically conductive material, or a third electrically conductive material, and the second housing wall further comprising: a third fastener hole configured for alignment with a fourth fastener hole of the exposed welding-type device component, and a second protrusion proximate the third fastener hole, a third insulating portion of the first or second electrically insulating coating of the second protrusion being configured for removal in response to a second clamp force being applied to a second housing fastener to connect the exposed welding-type device component to the second wall, such that a third conductive portion of the first or second electrically conductive material of the second protrusion is exposed, makes contact with, and becomes electrically continuous with, the exposed welding-type device component.

In some examples, the exposed welding-type device component comprises an electrical switch housing, a gas valve, a regulator, a gauge, a printed circuit board, an electrical port, or a handle. In some examples, the protrusion comprises a stamped or bent portion of the second housing wall, or the protrusion is attached to, and electrically continuous with, the second housing wall. In some examples, the protrusion comprises a first protrusion of a plurality of protrusions encircling the second housing wall hole.

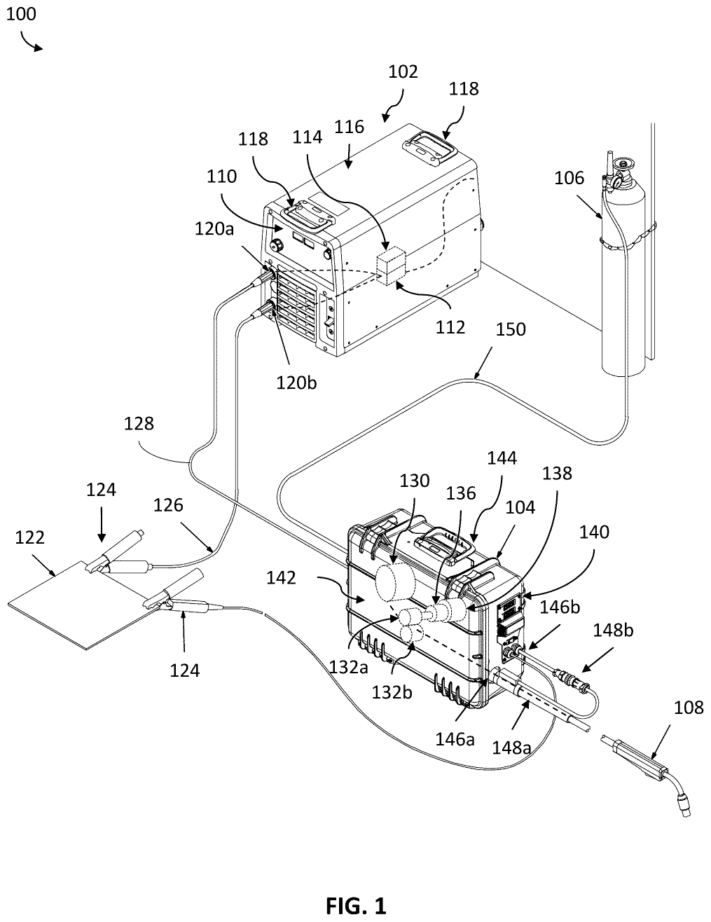

FIG. 1 shows an example of a welding-type system 100, such as may be used to conduct welding-type operations, for example. In some examples, the example welding-type system 100 shown in FIG. 1 may be used to conduct gas metal arc welding (GMAW) processes. In some examples, the welding-type system 100 may also be used with other arc welding processes, such as, for example, flux-cored arc welding (FCAW), gas shielded flux-cored arc welding (FCAW-G), gas tungsten arc welding (GTAW), submerged arc welding (SAW), shielded metal arc welding (SMAW), and/or other similar arc welding processes. In some examples, the welding-type system 100 may be used with metal fabrication systems, such as welding systems, plasma cutting systems, induction heating systems, and so forth.

In the example of FIG. 1, the welding-type system 100 includes a welding-type power supply 102, a welding wire feeder 104, a gas supply 106, and a welding-type tool 108. As shown, the welding-type power supply 102 includes a power supply user interface (UI) 110, power conversion circuitry 112, and power control circuitry 114 connected to the power conversion circuitry 112. While not explicitly shown in the example of FIG. 1, in some examples, the power control circuitry 114 of the welding-type power supply 102 may also be connected to the power supply UI 110.

In the example of FIG. 1, the welding-type power supply 102 further includes a power supply housing 116. The power supply housing 116 is additionally shown as including, and/or being attached to, power supply handles 118, by which an operator may carry the welding-type power supply 102. While the power supply UI 110 is shown as being at least partially exposed, and/or not entirely enclosed by the power supply housing 116, the power supply housing 116 is shown as substantially (and/or entirely) enclosing the control circuitry 114 and power conversion circuitry 112.

In some examples, the power conversion circuitry 112 of the welding-type power supply 102 is configured to receive input power (e.g., from a battery, generator, and/or mains power) and convert the input power to welding-type output power suitable for output to, and/or use by, a welding-type operation. In some examples, the power conversion circuitry 112 may include one or more rectifier circuits, pre-regulator circuits, and/or inverter circuits to conduct the conversion of the input power to welding-type output power (and/or auxiliary power). In some examples, the power conversion circuitry 112 may include one or more transformers, inductors, capacitors, resistors, diodes, and/or other circuit components to facilitate the conversion. In some examples, the power conversion circuitry 112 may include one or more controllable circuit elements, such as, for example, transistors, switches, and/or relays. In some examples, the power control circuitry 114 may be configured to control the conversion process of the power conversion circuitry 112 by controlling one or more of the controllable circuit elements via one or more control signals.

In some examples, the power supply UI 110 may comprise one or more output devices (e.g., lights, display screens, speakers, haptic devices, etc.) configured to output information to an operator regarding the operation of power control circuitry 114, power conversion circuitry 112, and/or other aspects of the welding-type power supply 102. In some examples, the power supply UI 110 may comprise one or more input devices (e.g., knobs, buttons, touch screens, switches, dials, keys, microphones, etc.) configured to receive inputs from the operator regarding the operation of the power control circuitry 114, power conversion circuitry 112, and/or other aspects of the welding-type power supply 102. In some examples, the power control circuitry 114 may control the power conversion circuitry 112 based on the input(s) received via the power supply UI 110.

In the example of FIG. 1, the power conversion circuitry 112 is connected to plug and socket connections 120. As shown, the welding-type power supply 102 is connected to the welding wire feeder 104, welding-type tool 108, and/or welding workpiece 122 through the plug and socket connections 120. In particular, the welding-type power supply 102 is coupled to the welding workpiece 122 through the work clamp 124, ground cable(s) 126, and the plug and socket connection 120b. The welding-type power supply 102 is connected to the wire feeder 104 (which is, in turn, connected to the welding-type tool 108) through one or more weld cables 128 and the plug and socket connection 120a.

In the example of FIG. 1, the welding wire feeder 104 retains a wire spool 130 (e.g., on a spindle) and includes wire feed rollers 132 configured to feed the wire from the wire spool 130 out of the welding wire feeder 104 to the welding-type tool 108 (e.g., via one or more feeder cables 134). As shown, one of the wire feed rollers 132a is coupled to a motor 136. In some examples, both wire feed rollers 132 may be coupled to the motor 136 (or multiple motors 136). In the example of FIG. 1, the wire feed motor 136 is in electrical communication with feeder control circuitry 138.

In the example of FIG. 1, the welding wire feeder 104 further includes a feeder UI 140. In some examples, the feeder UI 140 may include one or more output devices (e.g., lights, display screens, speakers, haptic devices, etc.) configured to output information regarding the operation of motor(s) 136, roller(s) 132, and/or other aspects of the welding wire feeder 104. In some examples, the feeder UI 140 may comprise one or more input devices (e.g., knobs, buttons, touch screens, switches, dials, keys, microphones, etc.) configured to receive inputs from the operator regarding the operation of the motor(s) 136, roller(s) 132, and/or other aspects of the welding wire feeder 104.

Though not explicitly shown for the sake of simplicity, in some examples, the feeder UI 140 may be in electrical communication with the feeder control circuitry 138. In some examples, the feeder control circuitry 138 may control the motor(s) 136, roller(s) 132, and/or other aspects of the welding wire feeder 104 based on the input(s) received via the feeder UI 140.

In the example of FIG. 1, the welding wire feeder 104 further includes a wire feeder housing 142. While the wire feeder housing 142 substantially (or entirely) encloses the wire spool 130, rollers 132, and motor(s) 136, the feeder UI 140, remains at least partially exposed, and/or is not entirely enclosed by the wire feeder housing 142. As shown, the wire feeder housing 142 also includes, and/or is attached to, a wire feeder handle 144 that might allow an operator to carry the wire feeder 104.

In the example of FIG. 1, the wire feeder 104 also includes sockets 146 connected to a power plug and cable 148a and trigger plug and cable 148b of the welding-type tool 108. In some examples, the wire feeder 104 may receive one or more activation signals from the welding-type tool 108 via the trigger plug and cable 148b (e.g., representative of an activation/trigger pull status). In some examples, the wire feeder 104 may route welding-type power (e.g., received from the welding-type power supply 102 via welding cable(s) 128) and/or welding wire (e.g., fed from the wire spool 130 via roller(s) 132) to the welding-type tool 108 in response to one or more activation signals received from the welding-type tool 108.

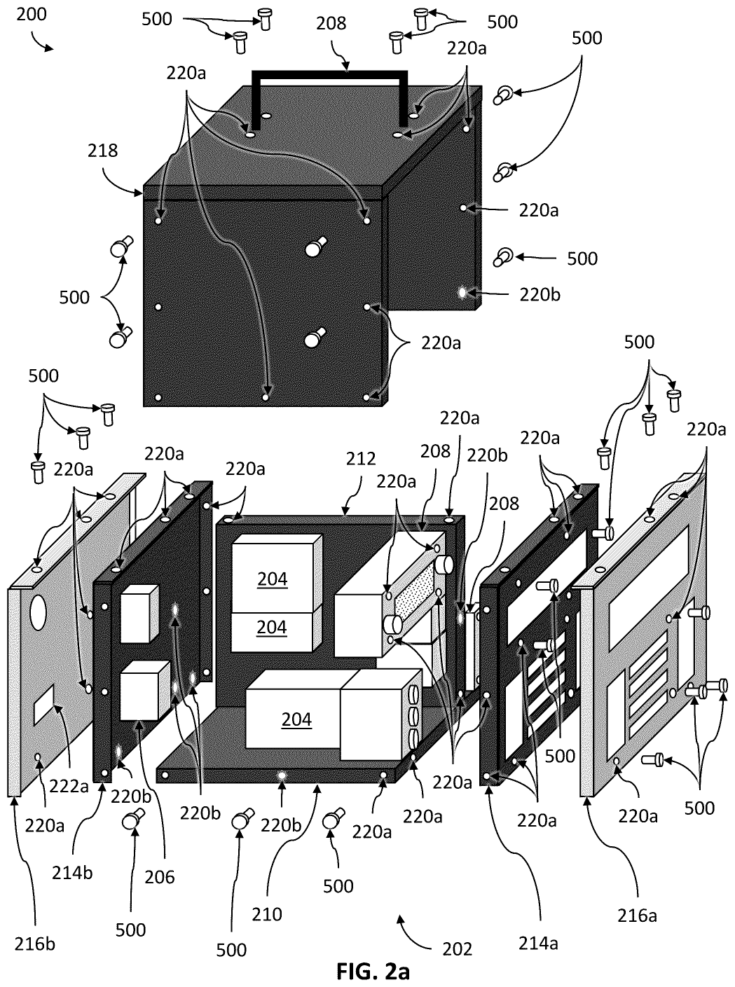

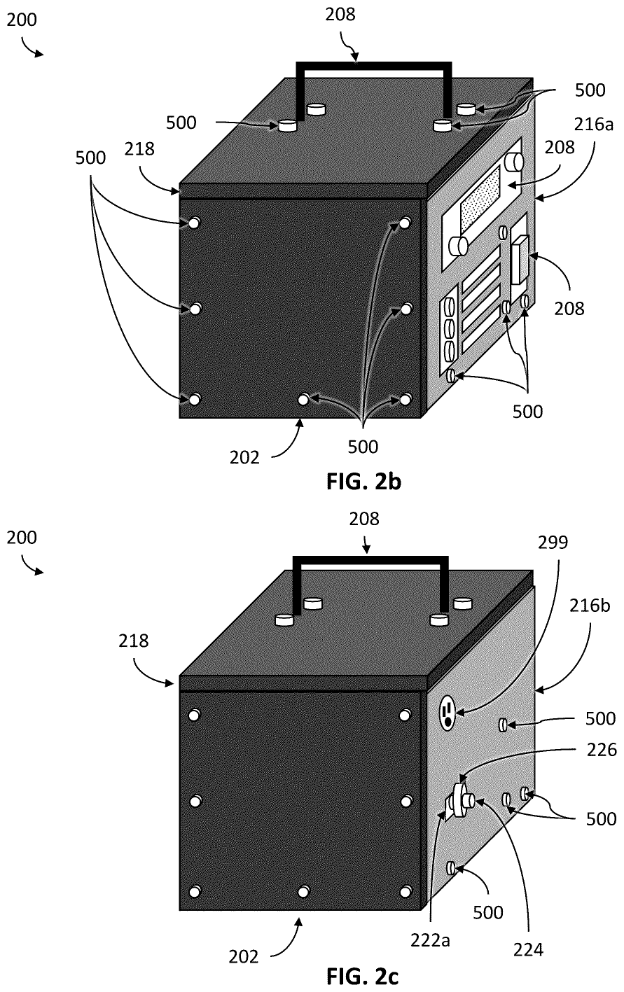

In the example of FIG. 1, the welding wire feeder 104 is also coupled to the gas supply 106 via gas line 150. In some examples, the welding wire feeder 104 may receive gas from the gas supply 106 at a gas valve 206 of the welding wire feeder 104 (see, e.g., FIG. 2a). In some examples, the feeder control circuitry 138 may control the gas valve 206, and thereby control delivery of shielding gas to the welding-type tool 108 (e.g., via the power plug and cable 148a). In some examples, the wire feeder 104 may route shielding gas to the welding-type tool 108 (e.g., via the power plug and cable 148a) in response to one or more activation signals received from the welding-type tool 108.

While shown as connected to the wire feeder 104 in the example of FIG. 1, in some examples, the gas supply 106 may instead be connected to the welding-type power supply 102, which may, in such examples, include its own gas valve(s) 206. While shown as separate and distinct in the example of FIG. 1, in some examples the welding wire feeder 104 may be part of, and/or incorporated by, the welding-type power supply 102.

FIGS. 2a-2c are exploded and assembled views of an example welding-type device 200 that might be used in the welding-type system 100 of FIG. 1. In some examples, the welding-type device 200 might be a welding-type power supply 102, welding wire feeder 104, or other welding-type device 200 (e.g., torch cooler, fume extractor, etc.). As shown, the welding-type device 200 includes a welding-type device housing 202 that encloses several enclosed device components 204 (e.g., power conversion circuitry 112, power control circuitry 114, feeder motor(s) 136, feed roller(s) 132, feeder control circuitry 138, etc.).

In the examples of FIGS. 2a-2c, the welding-type device 200 further includes a gas valve 206 (and/or gas regulator) and several other exposed device components 208. In some examples, exposed device components 208 may include one or more power supply UIs 110, feeder UIs 140, (e.g., UI) printed circuit boards (PCBs), (e.g., UI) switches and/or switch housings, (e.g., gas/pressure) regulators, (e.g., gas/pressure) gauges, (e.g., communication, universal serial bus (USB), auxiliary power, etc.) electrical connectors/ports, power supply handles 118, feeder handles 144, and/or other exposed components. In some examples, each of the exposed device components 208 may be partially, or entirely, comprised of an electrically conductive material, such as, for example, brass, steel, copper, aluminum, and/or other metal material. As shown, the gas valve 206 and/or other exposed device components 208 are partially, but not entirely, enclosed by the welding-type device housing 202.

While not explicitly shown, in some examples, the welding-type device 200 may further include an equipment grounding conductor. In some examples, the equipment grounding conductor may include and/or be in electrical communication with an equipment grounding conductor port of an input power port 299 (sec, e.g., FIG. 2c), through which the welding-type device 200 may receive input power (e.g., via a connected power cable). In some examples, the equipment grounding conductor may be electrically connected to, and/or be electrically continuous with, the welding-type device housing 202 (e.g., via an electrical stud—not shown).

In the example of FIGS. 2a, the welding-type device housing 202 includes a base 210 connected to a baffle 212, a front panel 214a, a rear panel 214b, a front bezel 216a, a rear bezel 216b, and a wrapper 218. As shown, the base 210 makes up a bottom wall of the welding-type device housing 202. The wrapper 218 includes a top wall and sidewalls. The front panel 214a and front bezel 216a each may be considered a front wall or a portion of the front wall. Likewise each of the rear panel 214b and rear bezel 216b may be considered a rear wall or a portion of the rear wall. In some examples, the baffle 212 may be considered an internal wall and/or part of the base 210.

In the example of FIG. 2a, the base 210, baffle 212, front panel 214a, front bezel 216a, rear panel 214b, rear bezel 216b, and wrapper 218 include fastener holes 220 sized and/or configured to receive (e.g., the fastener shanks 502 of) housing fasteners 500. As shown, the fastener holes 220 of the front panel 214a align with fastener holes 220 of the front bezel 216a, which also align with fastener holes 220 of the base 210 and baffle 212. Similarly, fastener holes 220 of the rear panel 214b align with fastener holes 220 of the rear bezel 216b, which also align with fastener holes 220 of the base 210 and baffle 212. And fastener holes 220 in the sidewall of the wrapper 218 align with align with fastener holes 220 in the front panel 214a, rear panel 214b, base 210, and baffle 212.

Some of the fastener holes 220 of the front panel 214a additionally align with fastener holes 220 of exposed device components 208. Though not shown due to perspective, some of the fastener holes 220 in the top wall of the wrapper 218 align with fastener holes 220 of (e.g., a flange of) an exposed device component 208 (e.g., handle). And a gas valve hole 222 of the rear panel 214b aligns with a gas valve hole 222 of the rear bezel 216b (e.g., to receive a gas valve connector 224 of the gas valve 206; see e.g., FIG. 2c).

In some examples, fasteners 500 may be extended through the various aligned fastener holes 220 to connect together the different portions of the welding-type device housing 202 (e.g., connecting together the base 210, baffle 212, front panel 214a, rear panel 214b, front bezel 216a, rear bezel 216b, and wrapper 218). In some examples, an axial tension force (also known as “clamp force”) may be exerted on each housing fastener 500 (and/or the fastener head 504 of each fastener 500) to connect together the different portions of the welding-type device housing 202, via the fasteners 500. In some examples, the clamp force may be further applied to housing fasteners 500 to connect the exposed device components 208 to the panels 214. In some examples, the clamp force may be further applied to housing fasteners 500 to connect the enclosed device components 204 and/or exposed device components 208 to the base 210 and/or baffle 212.

When all the different portions of the welding-type device housing 202 are connected together, and the housing 202 is assembled, the wrapper 218 wraps around portions of base 210, baffle 212, front panel 214a, front bezel 216a, rear panel 214b, and rear bezel 216b, thereby enclosing the enclosed device components 204 within the welding-type device housing 202 (sec, e.g., FIGS. 2b-2c). However, while some portions of the exposed device components 208 may be enclosed within the welding-type device housing 202 when the housing 202 is fully assembled, other portions of the exposed device components 208 extend across and/or outside the welding-type device housing 202, or are otherwise not enclosed by the welding-type device housing 202 (see, e.g., FIGS. 2b-2c).

While discussed herein as enclosing the enclosed device components 204, a person of ordinary skill will recognize that the welding-type device housing 202, when fully assembled, may be less than air tight. For example, the front panel 214a and front bezel 216a are shown as including vents that may allow air to circulate. Nevertheless, as the majority of enclosed device components 204 are substantially surrounded on all sides by portions of the welding-type device housing 202, persons of ordinary skill would understand the enclosed device components 204 to be enclosed within the welding-type device housing 202.

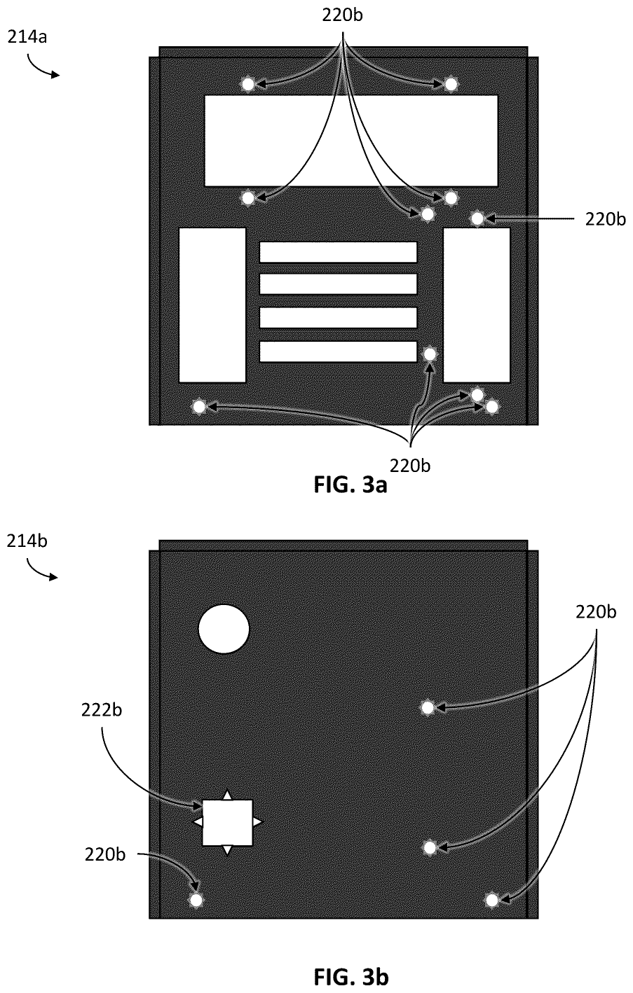

In the example of FIG. 2a, some of the fastener holes 220 are normal fastener holes 220a, while other are protruding fastener holes 220b. In the examples of FIGS. 2a, 3a, and 3b, the protruding fastener holes 220b are shown on the inner faces of the panels 214, an inner face of the wrapper 218, and on the base 210 and baffle 208. FIG. 3b additionally shows a protruding gas valve hole 222b on the rear panel 214b (as opposed to the normal gas valve hole 222a shown on the rear bezel 216b in FIGS. 2a and 2c). In some examples, the protruding gas valve hole 222b may be considered a protruding fastener hole 220b for purposes of the discussion below.

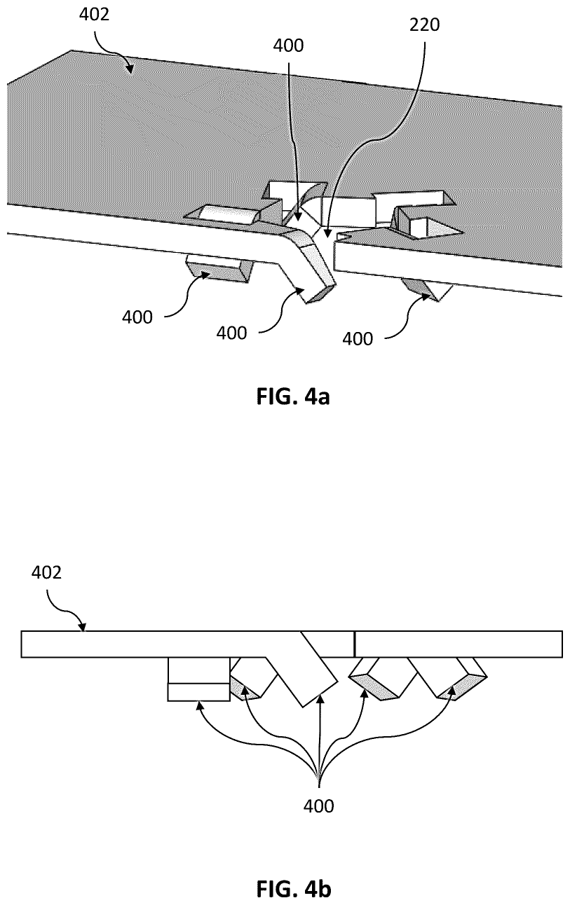

In the examples of FIGS. 2a, 3a, and 3b, each protruding fastener hole 220b is shown as comprising a hole encircled by triangles. The triangles are representative of protrusions 400, such as shown, for example, in FIG. 4. Though a certain number of triangles are shown encircling each fastener hole 220a in the examples of FIGS. 2a and 3a-3b, in some examples, more or fewer protrusions 400 may be used.

FIGS. 4a-4b show close up/zoomed in views of example protrusions 400 formed in or on a housing surface 402 (e.g., of a panel 214, base 210, baffle 212, and/or wrapper 218 of the housing 202). In some examples, the protrusions 400 are stamped, bent, and/or otherwise altered portions of a housing surface 402. In some examples, the protrusions 400 may alternatively, or additionally, comprise separate elements that are attached to the housing surface 402.

In the examples of FIGS. 4a-4b, each protrusion 400 is bent (e.g., with respect to the planar housing surface 402). In some examples, one or more of the protrusions 400 may be bent at an angle between 15 and 165 degrees). In some examples, the angle may be between 15 and 75 degrees (or 105 and 165 degrees). In some examples, the angle of each protrusion 400 (or some protrusions 400) may be approximately (e.g., within 5 degrees) the same as the angle of each other protrusion 400. In some examples, each protrusion 400 (or some protrusions 400) may be angled differently than each other protrusion 400.

In some examples, each protrusion 400 may terminate at a relatively sharp end. While the ends are shown as being somewhat blunt or cubed in the zoomed in examples of FIGS. 4a-6c, that which appears blunt or cubed at a high magnification may be relatively sharp at normal magnification. The sharpness of the protrusions 400 may aid the protrusions 400 in piercing, puncturing, scraping, abrading, and/or otherwise moving/removing a powder coating finish from certain portions of the welding-type device housing 202.

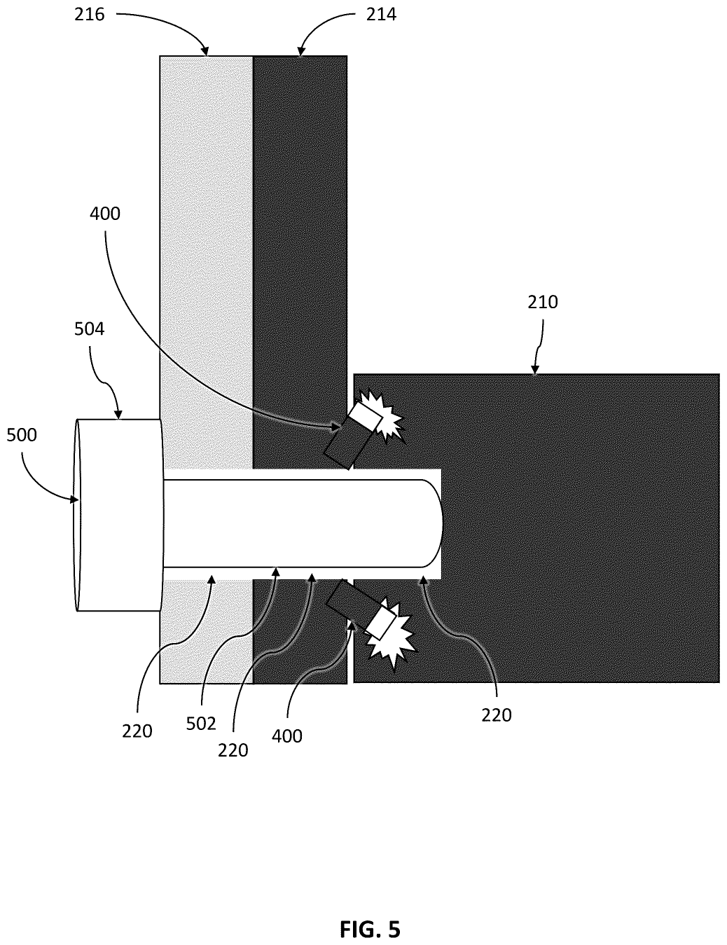

Because the protrusions 400 are positioned proximate to fastener holes 220 (e.g., with at least a portion of each protrusion within a radius of a fastener head 504; sec, e.g., FIG. 5), a clamp force that is applied to the fastener head 504 to fasten together the portions of the housing 202 may be transferred to the protrusions 400 (e.g., via the fastener head 504). The clamp force and the sharpness of the protrusions 400 may combine to move/remove a powder coating finish from certain portions of the welding-type device housing 202, and create electrical continuity between the underlying (e.g., metal) conductive material.

In some examples, the front panel 214a, rear panel 214b, base 210, baffle 212, and/or wrapper 218 may be entirely or substantially comprised of an electrically conductive material (e.g., steel or some other metal). In some examples, that electrically conductive material may be covered by a powder coating finish. In some examples, the finish may be used to protect against rust and/or other damage to the underlying material. However, the powder coating finish may also be electrically insulating, such that simple contact between the front panel 214a, rear panel 214b, base 210, baffle 212, and/or wrapper 218 may fail to create electrical continuity between the front panel 214a, rear panel 214b, base 210, baffle 212, and/or wrapper 218.

Electrical continuity between the welding-type device housing 202 and an equipment grounding conductor of the welding-type device 200 may be required by certain standards of several standards setting organizations. The standards may additionally require that the different housing surfaces 402 of the housing 202 be electrically continuous with one another. This electrical continuity may ensure that any fault electrical current that is conducted into the housing 202 will be subsequently conducted to ground. Some standards may similarly require the exposed (e.g., electrically conductive) device components 208 to be electrically continuous with the housing 202 for similar reasons.

In some examples, paint cutting fasteners (not shown) may be used to cut through the powder coating finish, and create electrical continuity with the underlying electrically conductive material. As discussed above, paint cutting fasteners may have a paint cutting ring on an inner side of their fastener head, and paint cutting screw threads on their fastener shank, both of which can be used to cut through the powder coating to get at the underlying conductive material of a housing surface 402. And since the paint cutting fastener itself is electrically conductive, electrical continuity can be created between the underlying conductive material of two adjoining housing surfaces 402 and the paint cutting fastener.

However, with respect to the housing 202 shown in FIGS. 2a-2c, the paint cutting fasteners may not be able to create electrical continuity between the front panel 214a and the base 210 (and/or baffle 212), and/or between the rear panel 214b and the base 210 (and/or the baffle 212), because of the positioning of the front bezel 216a and/or rear bezel 216b. As shown in the example of FIG. 2a, the fastener holes 220 of the front panel 214a are positioned between the front bezel 216a and the base 210 (and/or baffle 212). Likewise, the fastener holes 220 of the rear panel 214b are shown positioned between the rear bezel 216b and the base 210 (and/or baffle 212). Furthermore, while the front panel 214a and/or rear panel 214b may be comprised of electrically conductive material, in some examples, the front bezel 216a and/or rear bezel 216b may be entirely or substantially comprised of an electrically insulating material, such as, for example a plastic and/or polymer material.

Because of the positioning of the front bezel 216a and rear bezel 216b on the outside of the device housing 202, any (e.g., paint cutting) fastener extending through aligned fastener holes 220 with a fastener head on the outside of the housing 202 will abut and/or contact the front bezel 216a and/or rear bezel 216b, rather than the front panel 214a and/or rear panel 214b. While the screw threads of a paint cutting fastener might still cut through the insulating finish, and contact the underlying electrically conductive material of the base 210 (and/or baffle 212), there is no underlying electrically conductive material in the front bezel 216a (and/or rear bezel 216b) for the paint cutting ring to reach. Therefore the ability of the paint cutting fastener to create electrical continuity is significantly hindered when bezels 216 are used (as they are increasingly being used).

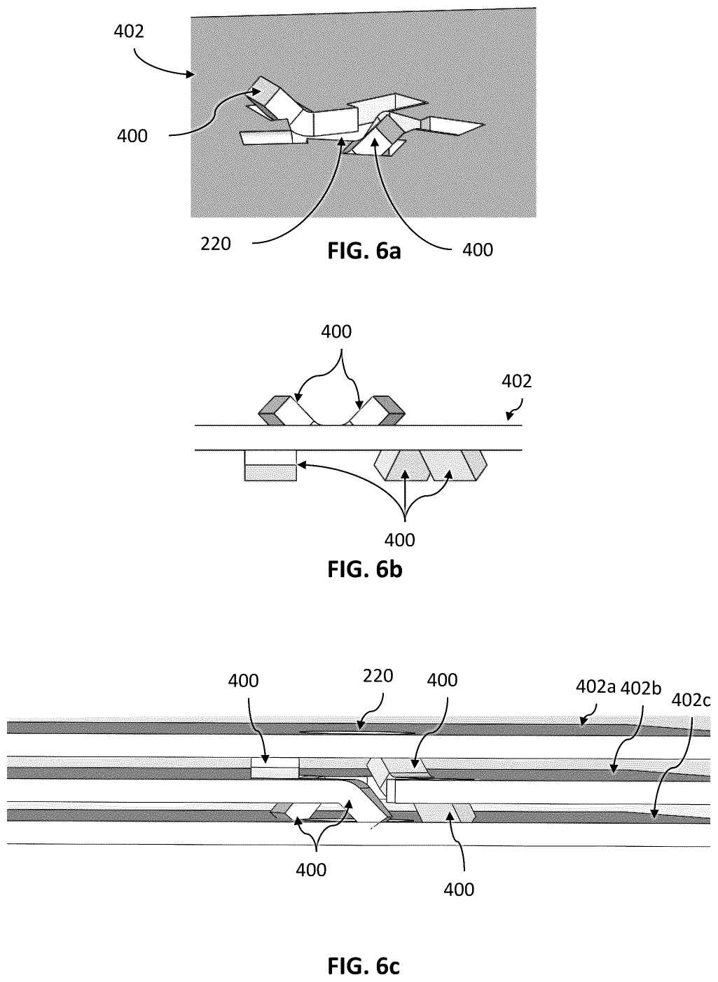

The present disclosure therefore contemplates the use of the protrusions 400 of the protruding fastener holes 220b to create electrical continuity. In the examples of FIGS. 2a, 3a, and 3b, some fastener holes 220 are shown as protruding fastener holes 220b on one face of a panel 214 and/or wrapper 218, and normal fastener holes 220a on an opposite face of the panel 214 and/or wrapper 218. This is to indicate that the protrusions 400 protrude from the face of the panel 214 and/or wrapper 218 shown as having the protruding fastener holes 220b (rather than from the face shown as having the normal fastener holes 220a). For example, in FIGS. 2a, 3a, and 3b the protruding fastener holes 220b are only shown on the inner faces of the front panel 214a and rear panel 214b, indicating that the protrusions 400 extend inward (e.g., towards the base 210 and/or baffle 212). However, in some examples, the protrusions 400 may extend from both faces of the panel 214 and/or wrapper 218 (see, e.g., FIGS. 6a-6c).

In some examples, the protrusions 400 are electrically continuous with, and/or part of, each housing surface 402. In some examples, the protrusions 400 may also be comprised of an electrically conductive material (e.g., the same, and/or same type of, electrically conductive material of the housing surface 402). In some examples, the conductive material of the protrusions 400 may also be covered by an insulating powder coating finish.

However, when the protrusions 400 cut through the powder coating finish on the base 210 (and/or baffle 212), the powder coating finish of the protrusions 400 may also be moved/removed (e.g., via abrasion). After the powder coating finish is moved/removed from both the protrusions 400 and the adjoining housing surface 402, the underlying electrically conductive material of the protrusions 400 come into electrical contact with, and/or become electrically continuous with, the adjoining housing surface 402. Thus, the protrusions 400 can be used to create electrical continuity between the different portions (and/or housing surfaces 402) of the housing 202, despite the presence of the bezels 216.

In some examples, several protruding fastener holes 220b are provided at several locations on each panel 214 and/or on the wrapper 218, with several protrusions 400 at each protruding fastener hole 220b. While a single protrusion 400 of a single protruding fastener hole 220b may be enough to create electrical continuity, in some examples, multiple protrusions 400 and/or multiple protruding fastener holes 220b may provide redundancy. Redundancy provided by the multiple protrusions 400 and/or protruding fastener holes 220b may be helpful in ensuring sufficient surface area is continuous throughout the welding-type device housing 202.

FIG. 5 shows a close up of a fastener 500 having a fastener head 504 abutting a bezel 216, and a fastener shank 502 extending through aligned fastener holes 220 of the bezel 216, a panel 214, and the base 210 of the housing 202. The protrusions 400 are shown proximate the fastener hole 220 of the panel 214 and well within the radius of the fastener head 504. This positioning allows for the clamp force applied to the fastener head 504 to be transferred to the protrusions 400, aiding in the abrasive impact of the protrusions 400.

In the example of FIG. 5, the light gray color of the bezel 216 is representative of an insulating material, while the darkened coloring of the panel 214, base 210, and protrusions 400 is representative of the powder coating finish, and the white coloring of the protrusions 400 and the base 210 is representative of the underlying electrically conductive material. Thus, FIG. 5 shows that the powder coating has been moved/removed from both the protrusions 400 and the base 210 around the fastener hole 220, and the underlying electrically conductive material of both are in electrical contact, thereby creating electrical continuity.

While, in some examples, it might be possible to attach a star washer around certain fastener holes 220 to achieve a similar abrasive impact as the protrusions 400, the star washer would not be in electrically continuous with the housing surface 402 to which it is attached due to the powder coating finish. Some other mechanisms would have to be used to remove the powder coating finish (e.g., grinding, masking dots, etc.) and/or create electrical continuity between the star washer and housing surface 402, and that other mechanism would likely have drawbacks, as discussed above. Additionally, the placement of the star washers would require additional human labor, add to costs, and be vulnerable to human error (e.g., w/r/t to correct and/or complete positioning and/or application), whereas the protrusions 400 may be formed from the housing surface 402 itself through the same process that makes the fastener holes, thereby ensuring electrical continuity with the housing surface 402, creating efficiencies, saving on time/labor, and reducing the potential for human error (e.g., w/r/t to correct and/or complete positioning and/or application).

In addition to creating electrical continuity between different portions of the welding-type device housing 202, in some examples, the protrusions 400 may also be used to bring certain exposed device components 218 into electrical continuity with the welding-type device housing 202. In some examples, some or all of the exposed device components 218 may be comprised of electrically conductive material, and, as discussed above, certain standards require exposed electrically conductive components of the welding-type devices 200 be electrically continuous with the welding-type device housing 202. While paint cutting fasteners can sometimes be used for this purpose (e.g., if there is no interfering bezel 216), it may nevertheless be cheaper to use protrusions 400 (due to the expense of paint cutting fasteners), and/or more reliable (as direct contact between housing surfaces 402 is generally considered more reliable than indirect contact through intermediate components for the purposes of electrical continuity).

FIG. 2c shows an example of an exposed device component 218 being made continuous with the welding-type device housing 202 via a fastener. In the example of FIG. 2c, the exposed device component 218 is a gas valve 206 having a gas valve connector 224 that extends through the gas valve hole 222 of the rear panel 214b and rear bezel 216b. As shown, the fastener is a fastening nut 226 that is screwed onto the gas valve connector 224 to secure the gas valve 206 to welding-type device housing 202.

In some examples, the gas valve 206 may be formed of an electrically conductive (e.g., brass) material, and/or may not be covered by a powder coating finish that must be abraded away by the protrusions 400. However, the powder coating of the protrusions 400 themselves may still be abraded away, such as shown in FIG. 5. In some examples, the protrusions 400 encircling the protruding gas valve hole 222b may be positioned on the inner face of the rear panel 214b within the radius of the fastening nut 226, such that the force of securing the fastening nut 226 on the gas valve connector 224 may be transferred to the protrusions 400, assisting in the abrasion process. FIGS. 2a and 3a further show protruding fastener holes 220b on the inner face of the front panel 214a that align with normal fastener holes 220a of several exposed device components 218, such that the exposed device components 218 may be made continuous with the welding-type device housing 202 via a housing fastener 500 (e.g., similar to that which is shown in FIG. 5).

While the protrusions 400 are shown in FIGS. 4a-5 as part of, and/or attached to, the housing surface 402 and extending from one face of the housing surface 402, in some examples, the protrusions 400 may instead extend from both faces of the housing surface 402. FIGS. 6a-6b, for example, show examples of protrusions 400 extending from both faces of the housing surface 402. FIG. 6c shows how this arrangement might be used where the housing surface 402b having the protrusions 400 is sandwiched between two other housing surfaces 402a, 402c, and all three surfaces 402 must be made electrically continuous.

While the protrusions 400 are shown in the example of FIG. 5 as extending from the (e.g., conductive) housing surface 402 closest to the fastener head 504 (e.g., to take advantage of the clamp force), in some examples, the protrusions may instead be part of, connected to, and/or extend from the housing surface 402 farther from the fattener head 504. However, having protrusions 400 extending from both faces of the housing surface 402 and/or from the housing surface 402 farther from the fastener head 504 may reduce the integrity of the fastener holes 220 and/or be less conducive to harnessing of the clamp force.

The present disclosure contemplates the use of protrusions 400 positioned around protruding fastener holes 220 of a welding-type device housing 202 to create electrical continuity between housing surfaces 402 of the welding-type device housing 202. The clamp forces and the sharpness of the protrusions 400 work together to pierce, puncture, scrape, abrade away, and/or otherwise move/remove insulating powder coatings of the housing 202 and the protrusions 400 when the housing 202 is assembled. The electrically conductive material underneath the powder coating is thereby exposed, and the exposed electrically conductive material of the protrusions 400 and the adjoining housing surface 402 may be put in contact with one another to create electrical continuity between the housing surface 402 with the protrusions 400 and the adjoining housing surface 402. A similar process may be used to create electrical continuity between the welding-type device housing 202 and certain exposed device components 218 of the welding-type device 200. The protrusions 400 may also be formed from the housing 202 itself through the same process that makes the fastener holes 220 of the housing 202, thereby creating efficiencies, saving on time/labor, and reducing the potential for human error (e.g., with respect to correct and/or complete positioning and/or application).

While the present apparatuses, systems, and/or methods have been described with reference to certain implementations, it will be understood by those skilled in the art that various changes may be made and equivalents may be substituted without departing from the scope of the present apparatuses, systems, and/or methods. In addition, many modifications may be made to adapt a particular situation or material to the teachings of the present disclosure without departing from its scope. Therefore, it is intended that the present apparatuses, systems, and/or methods not be limited to the particular implementations disclosed, but that the present apparatuses, systems, and/or methods will include all implementations falling within the scope of the appended claims.

In the above description, well-known functions or constructions are not described in detail because they may obscure the disclosure in unnecessary detail. For this disclosure, the following terms and definitions shall apply.

As used herein, the terms “about” and/or “approximately,” when used to modify or describe a value (or range of values), position, orientation, and/or action, mean reasonably close to that value, range of values, position, orientation, and/or action. Thus, the examples described herein are not limited to only the recited values, ranges of values, positions, orientations, and/or actions but rather should include reasonably workable deviations.

As utilized herein, the terms “e.g.,” and “for example” set off lists of one or more non-limiting examples, instances, or illustrations.

As used herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

As used herein, the terms “coupled,” “coupled to,” and “coupled with,” each mean a structural and/or electrical connection, whether attached, affixed, connected, joined, fastened, linked, and/or otherwise secured. As used herein, the term “attach” means to affix, couple, connect, join, fasten, link, and/or otherwise secure. As used herein, the term “connect” means to attach, affix, couple, join, fasten, link, and/or otherwise secure.

As used herein the terms “circuits” and “circuitry” refer to physical electronic components (i.e., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, circuitry is “operable” and/or “configured” to perform a function whenever the circuitry comprises the necessary hardware and/or code (if any is necessary) to perform the function, regardless of whether performance of the function is disabled or enabled (e.g., by a user-configurable setting, factory trim, etc.).

As used herein, a control circuit may include digital and/or analog circuitry, discrete and/or integrated circuitry, microprocessors, DSPs, etc., software, hardware and/or firmware, located on one or more boards, that form part or all of a controller, and/or are used to control a welding process, and/or a device such as a power source or wire feeder.

As used, herein, the term “memory” and/or “memory device” means computer hardware or circuitry to store information for use by a processor and/or other digital device. The memory and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like.

As used herein, the term “processor” means processing devices, apparatuses, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general purpose microprocessor or microcontroller, a digital signal processing (DSP) processor, an application-specific integrated circuit (ASIC). The processor may be coupled to, or integrated with a memory device.

The term “power” is used throughout this specification for convenience, but also includes related measures such as energy, current, voltage, and enthalpy. For example, controlling “power” may involve controlling voltage, current, energy, and/or enthalpy, and/or controlling based on “power” may involve controlling based on voltage, current, energy, and/or enthalpy.

As used herein, welding-type refers to welding, cladding, brazing, plasma cutting, induction heating, CAC-A and/or hot wire welding/preheating (including laser welding and laser cladding), carbon arc cutting or gouging, and/or resistive preheating.

As used herein, a welding-type device refers to a device used in or for welding, cladding, brazing, plasma cutting, induction heating, CAC-A and/or hot wire welding/preheating (including laser welding and laser cladding), carbon arc cutting or gouging, and/or resistive preheating.

As used herein, welding-type power refers to power suitable for welding, cladding, brazing, plasma cutting, induction heating, CAC-A and/or hot wire welding/preheating (including laser welding and laser cladding), carbon arc cutting or gouging, and/or resistive preheating.

As used herein, a welding-type power supply and/or power source refers to any device capable of, when power is applied thereto, supplying welding, cladding, brazing, plasma cutting, induction heating, laser (including laser welding, laser hybrid, and laser cladding), carbon arc cutting or gouging and/or resistive preheating, including but not limited to transformer-rectifiers, inverters, converters, resonant power supplies, quasi-resonant power supplies, switch-mode power supplies, etc., as well as control circuitry and other ancillary circuitry associated therewith.

What is claimed is:

1. A welding-type device housing, comprising:
a first housing wall comprising a first housing wall hole, the first housing wall being comprised of a first electrically conductive material that is covered by an electrically insulating coating; and
a second housing wall comprised of the first electrically conductive material, or a second electrically conductive material, the second housing wall comprising
a second housing wall hole configured for alignment with the first housing wall hole, and
a protrusion positioned proximate the second housing wall hole, the protrusion being configured to, when the second housing wall is fastened to the first housing wall, move an insulating portion of the electrically insulating coating of the first housing wall to expose a conductive portion of the first electrically conductive material that is underneath, and make contact with the conductive portion of the first electrically conductive material that is underneath.

2. The welding-type device housing of claim 1, wherein the second housing wall is configured to be fastened to the first housing wall by a housing fastener extending through the first housing wall hole and the second housing wall hole, the protrusion being configured to move the insulating portion of the electrically insulating coating of the first housing wall in response to a clamp force being applied to the fastener to fasten the second housing wall to the first housing wall.

3. The welding-type device housing of claim 2, further comprising an electrically insulating bezel comprising a bezel hole aligned with the first housing wall hole and the second housing wall hole, the second housing wall hole being positioned between bezel hole and the first housing wall hole, the electrically insulating bezel and the second housing wall being configured to be fastened to the first housing wall by the housing fastener extending through the bezel hole, the first housing wall hole, and the second housing wall hole.

4. The welding-type device housing of claim 3, wherein the second housing wall comprises a front panel wall or a rear panel wall, and the first housing wall comprises a base wall or a baffle wall.

5. The welding-type device housing of claim 2, wherein the insulating portion of the electrically insulating coating comprises a first insulating portion of a first electrically insulating coating, and the conductive portion of the first electrically conductive material comprises a first conductive portion of the first electrically conductive material,
wherein the first or second electrically conductive material of the second housing wall is covered with a second electrically insulating coating, or the first electrically insulating coating, and a second insulating portion of the first or second electrically insulating coating of the protrusion of the second housing wall is configured to be moved in response to the clamp force being applied to the housing fastener, such that a second conductive portion of the first or second electrically conductive material of the protrusion is exposed and makes contact with the first conductive portion of the first electrically conductive material of the first housing wall that was exposed.

6. The welding-type device housing of claim 5, wherein the contact between the second conductive portion of the protrusion and the first conductive portion of the first housing wall creates electrical continuity between the first housing wall and the second housing wall.

7. The welding-type device housing of claim 5, wherein the protrusion comprises a first protrusion, and the clamp force comprises a first clamp force, the second housing wall further comprising:
a third fastener hole configured for alignment with a fourth fastener hole of an exposed welding-type device component that is comprised of the first or second electrically conductive material, or a third electrically conductive material, and
a second protrusion proximate the third fastener hole, a third insulating portion of the first or second electrically insulating coating of the second protrusion being configured for removal in response to a second clamp force being applied to a second housing fastener to connect the exposed welding-type device component to the second wall, such that a third conductive portion of the first or second electrically conductive material of the second protrusion is exposed, makes contact with, and becomes electrically continuous with, the exposed welding-type device component.

8. The welding-type device housing of claim 7, wherein the exposed welding-type device component comprises an electrical switch housing, a gas valve, a regulator, a gauge, a printed circuit board, an electrical port, or a handle.

9. The welding-type device housing of claim 1, wherein the protrusion comprises a stamped or bent portion of the second housing wall, or the protrusion is attached to, and electrically continuous with, the second housing wall.

10. The welding-type device housing of claim 1, wherein the protrusion comprises a first protrusion of a plurality of protrusions encircling the second housing wall hole.

11. A welding-type device, comprising:
an enclosed device component comprising:
power conversion circuitry configured to receive input power and convert the input power into welding-type output power, or
a feed roller configured to feed welding wire from a wire spool to a welding application; and
a welding-type device housing enclosing the enclosed device component, the welding-type device housing comprising:
a first housing wall comprising a first housing wall hole, the first housing wall being comprised of a first electrically conductive material that is covered by an electrically insulating coating, and
a second housing wall comprised of the first electrically conductive material, or a second electrically conductive material, the second housing wall comprising:
a second housing wall hole configured for alignment with the first housing wall hole, and
a protrusion positioned proximate the second housing wall hole, the protrusion being configured to, when the second housing wall is fastened to the first housing wall, move an insulating portion of the electrically insulating coating of the first housing wall to expose a conductive portion of the first electrically conductive material that is underneath, and make contact with the conductive portion of the first electrically conductive material that is underneath.

12. The welding-type device of claim 11, wherein the second housing wall is configured to be fastened to the first housing wall by a housing fastener extending through the first housing wall hole and the second housing wall hole, the protrusion being configured to move the insulating portion of the electrically insulating coating of the first housing wall in response to a clamp force being applied to the fastener to fasten the second housing wall to the first housing wall.

13. The welding-type device of claim 12, wherein the welding-type device housing further comprises an electrically insulating bezel comprising a bezel hole aligned with the first housing wall hole and the second housing wall hole, the second housing wall hole being positioned between bezel hole and the first housing wall hole, the electrically insulating bezel and the second housing wall being configured to be fastened to the first housing wall by the housing fastener extending through the bezel hole, the first housing wall hole, and the second housing wall hole.

14. The welding-type device of claim 13, wherein the second housing wall comprises a front panel wall or a rear panel wall, and the first housing wall comprises a base wall or a baffle wall.

15. The welding-type device of claim 12, wherein the insulating portion of the electrically insulating coating comprises a first insulating portion of a first electrically insulating coating, and the conductive portion of the first electrically conductive material comprises a first conductive portion of the first electrically conductive material,
wherein the first or second electrically conductive material of the second housing wall is covered with a second electrically insulating coating, or the first electrically insulating coating, and a second insulating portion of the first or second electrically insulating coating of the protrusion of the second housing wall is configured to be moved in response to the clamp force being applied to the housing fastener, such that a second conductive portion of the the first or second electrically conductive material of the protrusion is exposed and makes contact with the first conductive portion of the first electrically conductive material of the first housing wall that was exposed.

16. The welding-type device of claim 15, wherein the contact between the second conductive portion of the protrusion and the first conductive portion of the first housing wall creates electrical continuity between the first housing wall and the second housing wall.

17. The welding-type device of claim 15, wherein the protrusion comprises a first protrusion, and the clamp force comprises a first clamp force,
the welding-type device further comprising an exposed welding-type device component that is comprised of the first or second electrically conductive material, or a third electrically conductive material, and the second housing wall further comprising:
a third fastener hole configured for alignment with a fourth fastener hole of the exposed welding-type device component, and
a second protrusion proximate the third fastener hole, a third insulating portion of the first or second electrically insulating coating of the second protrusion being configured for removal in response to a second clamp force being applied to a second housing fastener to connect the exposed welding-type device component to the second wall, such that a third conductive portion of the first or second electrically conductive material of the second protrusion is exposed, makes contact with, and becomes electrically continuous with, the exposed welding-type device component.

18. The welding-type device of claim 17, wherein the exposed welding-type device component comprises an electrical switch housing, a gas valve, a regulator, a gauge, a printed circuit board, an electrical port, or a handle.

19. The welding-type device of claim 11, wherein the protrusion comprises a stamped or bent portion of the second housing wall, or the protrusion is attached to, and electrically continuous with, the second housing wall.

20. The welding-type device of claim 11, wherein the protrusion comprises a first protrusion of a plurality of protrusions encircling the second housing wall hole.
